(19) United States
(12) Patent Application Publication
(10) Pub. No.: US 2020/0023481 A1
(43) Pub. Date: Jan. 23, 2020

(54) TRANSPORT APPARATUS, METHOD AND COMPUTER PROGRAM PRODUCT FOR LOADING AND UNLOADING AT LEAST ONE MATERIAL MACHINING UNIT

(71) Applicant: Bystronic Laser AG, Niederoenz (CH)

(72) Inventor: Ernest IMBODEN, Steinhof (CH)

(73) Assignee: Bystronic Laser AG, Niederoenz (CH)

(21) Appl. No.: 16/343,190

(22) PCT Filed: Oct. 18, 2017
(86) PCT No.: PCT/EP2017/076622

§ 371 Date: Oct. 1, 2019

(30) Foreign Application Priority Data
Oct. 19, 2016 (EP) 16194691.8

(51) Int. Cl. B23Q 11/08; B23Q 39/02; B23Q 7/04; B21D 43/20

(52) U.S. Cl. CPC B23Q 11/0891; B23Q 11/0866; B21D 43/20; B23Q 7/046; B23Q 7/047; B23Q 39/022

(57) ABSTRACT

The invention relates to a transport apparatus (10) for the collision-free loading and unloading of a material machining unit (1) with a workpiece (5) comprising a guide apparatus (60), a plurality of transport devices (15, 16, 17, 18), wherein one of the transport devices (15) is arranged on a first transport device level (20), as well as another transport device (16) being arranged on another transport device level (21). A multifunctional tooling apparatus (25) for transporting and/or machining the workpiece (5) or the workpiece part is arranged on the transport device (15). Furthermore, the invention relates to a method for loading and unloading the material machining unit (1) using such a transport apparatus (10), as well as a computer program product for loading and unloading according to this method and using such a transport device (10).

The invention relates to a transport apparatus for loading and unloading at least one material machining unit according to the preamble of claim 1. Furthermore, the invention relates to a method for loading and unloading the material machining unit under the use of such a transport apparatus according to claim 15, as well as a computer program product for automatically carrying out a process sequence under the use of such a method and such a transport apparatus according to claim 17.

In the field of industrial manufacturing, apparatuses and methods for loading and unloading material machining units are used in a versatile manner, such as laser cutting machines or fluid-jet cutting machines, such as water-jet cutting machines. In order to increase the productivity of material machining units, transport apparatuses and methods for loading and unloading material machining units with workpieces are carried out and operated fully automatically. In the case of large-scale plants, the unmachined workpiece are transported from a workpiece storage system to the material machining unit, machined and then either stored in another workpiece storage system or stacked next to the material machining unit. The workpiece parts that have already been machined are mostly subjected to high levels of mechanical load, wherein workpiece scrap is massively increased due to workpiece parts that have already been machined being damaged.

CN101623796A shows a transport apparatus for the automated loading and unloading of a laser cutting machine with a pelletizing robot for sorting the workpieces and an unloading robot, both of which are movably arranged on a guide rail.

A disadvantage of this transport apparatus is that the two moveable robots cannot intersect in their movement direction along the guide rail and workpiece machining using these robots cannot be carried out. Therefore, the known transport apparatus is unsuitable for complex process work steps with a high throughput.

Friedrich Remmert GmbH offers a transport apparatus for loading and unloading a material machining unit with a plurality of transport devices under the name “Laser FLEX”, which are movably arranged along a guide apparatus on two transport device levels.

A disadvantage of this transport apparatus is that only simple loading steps and unloading steps of standardized-size workpieces can be carried out using this transport apparatus, whereby a high level of downtime arises during the process and productivity of the overall plant is considerably reduced.

WO2008/139409A1 shows a transport apparatus for loading and unloading cutting machines comprising a pair of rails as guide apparatus carriers for guiding moveable robot units, which comprise moveable tooling apparatuses with a magnetic pickup head and an aspiration device. This transport apparatus furthermore comprises a stationary tool changing station for storing various aspiration tools, which are arranged, if needed, on the mechanical transport unit.

Unfavourably, the known transport apparatus only has a movement level for the horizontal movement of the robot units, whereby only a simple loading and unloading is possible, subject to a low level of productivity as well as a low level of workpiece transport capacity.

The object of the present invention is to create a transport apparatus for loading and unloading at least one material machining unit with at least one workpiece, which does not have the aforementioned disadvantages and, in particular, in the case of complex loading steps and unloading steps, has a high level of transport capacity, as well as makes process work steps on the workpiece or on a workpiece part detached from a workpiece that are gentle on the workpiece or the workpiece part possible. Furthermore, it is the object of the invention to make a method for loading and unloading with at least one workpiece or at least one workpiece part detached from a workpiece using a transport apparatus and to provide a computer program product for such a method.

This task is achieved by means of the features of the independent claims. Favourable further embodiments are shown in the figures and in the dependent patent claims.

In accordance with the invention, this is achieved in the case of a transport apparatus for loading and unloading at least one material machining unit with at least one workpiece or with at least one workpiece part detached from a workpiece, a guide apparatus, a plurality of transport devices, which are arranged on the guide apparatus, wherein one of the transport devices is arranged on a first transport device level and comprises at least one moveable tooling apparatus, by means of the fact that at least one other transport device level is provided, in which at least one of the other transport devices is arranged, as well as that the at least one tooling apparatus is multifunctionally designed to transport the workpiece or is designed with at least one workpiece part detached from a workpiece.

By means of such a transport apparatus, the production capacity and the transport capacity in an industrial plant with at least one material machining unit can be considerably improved since, simultaneously, a plurality of process work steps can be carried out on the various transport device levels of the transport apparatus. Due to the integration of other process work steps, downstream (mostly manual) work steps are prevented, whereby the entire process sequence is improved. The multifunctional tooling apparatus makes a quick and gentle loading and unloading of workpieces or previously machined workpiece parts of the at least one material machining unit, whereby workpiece scrap is considerably reduced.

In an alternative embodiment of the transport apparatus, the at least one multifunctional tooling apparatus is designed for machining the workpiece or designed with at least one workpiece part detached from a workpiece, whereby a workpiece machining is made directly possible in the and using the transport apparatus. Thereby, process work steps, such as the removal or cutting scrap on the workpiece, can be carried out in the transport apparatus. This allows a stacking of machined workpieces or workpiece parts in a manner that is gentle on the workpieces and prevents damage from occurring on the already machined workpiece.

In another alternative, the at least one multifunctional tooling apparatus is designed for transporting and for machining the workpiece or the at least one workpiece part detached from a workpiece. Thereby, complex process work steps can be carried out in the transport apparatus without the workpiece or the workpiece part having to leave the transport apparatus or having to be transported out of this. This leads to a massive productivity improvement during the entire process sequence in an industrial plant with at least one material machining unit.

Under the term workpiece, in this connection, in addition to an unmachined workpiece with a large area, a previously machine workpiece is also understood, such as a semi-finished product or sheet skeletons. Thereby, diverse materials can be used for the workpiece, as well as for a workpiece part detached from a workpiece, such as a raw metal sheet, a glass plate or a cut metal sheet.

Under the term multifunctional tooling apparatus, in this connection, a tooling apparatus is understood, which is designed for carrying out a plurality of process work steps or process steps with variously complex degrees of difficulty and, favourably, a gentle treatment of the workpiece or workpiece part detached from a workpiece is made possible. In this connection, under the term process work step, any process is understood that is carried out on the workpiece. Not being an exhaustive list, a process work step comprises a transport, a positioning, a cleaning, a marking, a labelling, a sorting, a mechanical machining, such as thread cutting, milling, chamfering, attaching threaded inserts, attaching welding studs, as well as laser machining, fluid-jet machining, coating etc. of the workpiece in the transport apparatus.

In this connection, under the term process step, any process is understood which is carried out without direct relation to a workpiece, such as changing a workpiece on a tooling apparatus for example. Process work steps and process steps together define a process sequence.

A transport device level is a level in the transport apparatus, which is spanned by two straight lines, which are, in particular, orthogonal to one another. The first one of these straight lines is relatively arranged along the longitudinal extension of the at least first transport device in the transport apparatus and the second of these straight lines is orientated along the movement direction of the at least first transport device in the transport apparatus. The first transport device level is arranged relative to another transport device level, being favourably arranged in parallel to it. In a variant of this, the transport device levels can also at least partially run at an angle relative to one another.

Preferably, the at least one multifunctional tooling apparatus is arranged in a linearly moveable manner on one of the transport devices, whereby the transport capacity of the transport apparatus with transport devices on various transport device levels is increased. A linearly moveable tooling apparatus arranged on the transport device can also carry out other process work steps on the workpiece or other process steps in the transport apparatus in addition to a transport work step. Simultaneously, one of the transport devices on another transport device level carries out a process work step on another workpiece, wherein the process sequence takes place in parallel and in a collision-free manner. The linearly moveable tooling apparatus, which can be moved out, and in particular, can be moved fully out of a transport device level and into at least one other transport device level makes a particularly flexible use and a constructively simple structure of the multifunctional tooling apparatus possible. Under the term linearly moveable, in this connection, a movement along a straight line is understood, which is orientated relative to the transport device. For example, (however, not limiting), the tooling apparatus can be linearly moved along a straight line, which is orientated vertically to the transport device. Thereby, a particularly simple movement of the tooling apparatus on the transport device can be implemented, for example, by means of an extendable and retractable arm, favourably a telescopic arm that can be extended and retracted in a linear manner.

In an alternative embodiment, the multifunctional tooling apparatus is arranged on the at least one transport device in a pivotably moveable manner, whereby a particularly space-saving embodiment of the transport device is formed since the tooling apparatus can be fully pivoted out of the transport device level. This is particularly favourable in the case of using the transport apparatus in production halls with limited space, in particular, in relation to the inner height of the production hall. A low level of design height of the transport apparatus is also favourable if the transport apparatus, for example, should be preloaded as a whole into a transport container, for example, in order to make a particularly quick and inexpensive transport of the transport apparatus to an industrial plant possible.

As an alternative, the tooling apparatus is arranged on the at least one transport device in a pivotable and linearly moveable manner. A pivotable and linearly moveable tooling apparatus can be used in a particularly flexible manner since, in addition to a collision-free process work step along a straight line, which is favourably arranged relative to the perpendicular of the tooling apparatus, can be carried out on the one transport device level or on the at least one other transport device level within the transport apparatus. The pivoting movement and the linear movement of the tooling apparatus can be carried out either simultaneously or successively.

As an alternative, the tooling apparatus is rotatably arranged on the at least one transport device, whereby a simple and compact realization of a moveable tooling apparatus is implemented and other process work steps can be carried out along another straight line, which is favourably arranged relative to the perpendicular of the tooling apparatus, on the at least one transport device level or the other transport device level within the transport apparatus.

As an alternative, the tooling apparatus is arranged on the at least one transport device in a rotatable and pivotably moveable manner, whereby another inexpensive and space-saving arrangement of the tooling apparatus can be implemented on the transport device. The pivoting movement and the rotational movement of the tooling apparatus can be carried out either simultaneously or successively.

As an alternative, the tooling apparatus is arranged on the at least one transport device in a rotatable and linearly moveable manner. A rotatable and linearly moveable tooling apparatus can be used for the collision-free implementation of complex process work steps, which are carried out outside of the transport device levels. The pivoting movement and the rotational movement of the tooling apparatus can both be carried out simultaneously or successively.

As an alternative, the tooling apparatus is arranged on the at least one transport device in a pivotable, rotatable and linearly moveable manner. The arrangement shape of the tooling apparatus on the at least one transport device is suitable for highly complex process work steps or process steps on the at least one transport device level or on the other transport device level within the transport apparatus. Furthermore, such a multifunctional tooling apparatus can be used during the process sequence across a large working region of the transport apparatus in a collision-free manner, whereby transport capacity is considerably increased. The pivoting movement and the rotational movement, as well as the linear movement of the tooling apparatus can be carried out either simultaneously or successively.

In a preferred embodiment, the at least one tooling apparatus is moveably arranged along the at least one transport device, whereby the working region of the tooling apparatus within the transport apparatus is expanded and workpiece positions that are otherwise inaccessible become accessible for the tooling apparatus. Favourably, at least one movement apparatus is provided for the tooling apparatus, which, for example, comprises a guide system, which, on the one hand, is arranged on the transport device, and is arranged on the tooling apparatus on the other. Thereby, the movement of the tooling apparatus along the transport device can be easily guided and the tooling unit is easily moveable, for example, from a possible region where collision may occur with other transport devices.

Preferably, the at least one multifunctional tooling apparatus comprises at least one tooling unit for machining and/or transporting a workpiece or at least one workpiece part detached from the workpiece, whereby at least one complex process work step can be carried out directly in the transport apparatus. Thereby, tremendous time savings can be achieved during the process sequence and, thereby, an increased workpiece throughput.

Preferably, the tooling unit can be moved relative to the transport device level, whereby, starting from the at least one tooling unit on a first transport device level, at least one process work step can be easily carried out on another workpiece on at least one other transport device level using the tooling unit. Thereby, the process work step of the moveable tooling unit can be carried out simultaneously with a process work step of one of the other transport devices on the other transport device level in a collision-free manner, whereby the efficiency of the process sequence is improved.

Favourably, the at least one multifunctional tooling apparatus comprises a movement device, which is furthermore favourably arranged between at least one end of the tooling unit and the tool. The movement device makes a relative movement of the tool towards the tooling unit possible, whereby flexible and complex process work steps can be carried out on the workpiece within the transport apparatus. The movement device comprises a pivoting joint and/or rotatable joint for example, around which the workpiece or at least one part of the tooling unit is pivotable and rotatable.

Preferably, the at least one tooling apparatus comprises at least one other tooling unit for machining and/or transporting a workpiece or at least one workpiece part detached from a workpiece, whereby another process work step can be implemented on the workpiece using the at least one other tooling unit. This makes a quick and elaborate machining and/or a quicker transport possible, whereby the productivity is further increased during the process sequence in the transport apparatus.

Preferably, the at least one tooling apparatus is pivotable and/or rotatable around an axis, which is orientated in parallel to at least one transport device level of the transport apparatus. This makes a defined movement of the tooling apparatus possible, which thereby allows for a precise execution of a process work step on the workpiece or the workpiece part on the one hand and, on the other, prevents an undesired collision, for example, a collision of the tooling apparatus with a transport device on the other transport device level. Thereby, it is favourable that the axis arranged in parallel to the transport device level can be relatively positioned around an axis arranged normally towards a transport device level, whereby an extensive and complex positioning of the at least one tooling apparatus is possible.

As an alternative, the tooling apparatus can be pivoted or rotated around another axis, which is normally orientated towards at least one transport device level of the transport apparatus, whereby a space-saving transport apparatus is implemented. The transport device together with the tooling apparatus can stay at their position and must not be moved into a park position in order to avoid an otherwise possible collision with one of the other transport devices.

As an alternative, the at least one tooling apparatus can be pivoted or rotated around an axis, which is orientated in parallel to the at least one transport device level of the transport apparatus and can be pivoted or rotated around another axis, which is orientated normally to the at least one transport device level of the transport apparatus. Thereby, increased movement flexibility of the tooling apparatus is achieved with regard to the at least one transport device level and an elevated process sequence complexity can be implemented. By means of this, a multiplicity of process work steps, for example, transporting or machining into a direction relative to the transport device levels can be carried out.

As an alternative, the at least one tooling apparatus is arranged in a linearly moveable manner along at least one of the aforementioned axes, whereby a particularly simply constructed and inexpensive embodiment is possible.

As an alternative, the at least one tooling apparatus can be pivoted or rotated around the access, which is orientated in parallel to the at least one transport device level and can be pivoted or rotated around another axis, which is orientated normally to the at least one transport device level of the transport apparatus and is arranged in a linearly moveable manner along at least one of these axes. Thereby, the advantage of a space-saving embodiment can be combined with a complex process sequence in a collision-free manner and the use of the transport apparatus in industrial buildings with a low level of ceiling height is possible.

Preferably, the at least one tooling apparatus comprises one detection unit for detecting a process parameter, whereby for example, a predefined machining position on the workpiece can be detected. Thereby, a marking on the workpiece or a previously known machining position can subsequently be detected again. Thereby, a process work step on a workpiece or a workpiece part that has already been machined in a material machining unit can be further machined without the workpiece or the workpiece part being having to be removed from the transport apparatus. Particularly in the case of simple process work steps, such as deburring cut edges, an increased productivity is thereby possible without additional external machining units.

Favourably, the detection unit of the at least one tooling apparatus comprises a detector for detecting a process parameter. The process parameter is, for example, detected or recorded by means of a an image detection unit or an electromagnetic detection unit and then favourably further machined in a prompt manner, whereby, an intervention can be made into the corresponding process sequence, for example, of the tooling apparatus, of a transport device, of the transport apparatus or even into the at least one material machining unit.

Preferably, the at least one tooling unit comprises a tool. With the aid of the tool, machining steps can be carried out on the workpiece or on the workpiece part using the tooling apparatus.

Preferably, the at least one tooling unit comprises a tool holding unit for holding at least one tool, whereby a tooling unit, if required and favourably in a controlled manner, can hold a plurality of different tools four machining and/or transporting the workpiece or workpiece part and, therefore, can be used in a particularly flexible manner.

Preferably, the tool of the tooling apparatus can be chosen from the group of manufacturing tools, such as a forming tool, a separation tool, a joining tool, a coating tool as well as a generative manufacturing method tool. Thereby, favourably, the tools adapted to the respective process work step can be used and process work steps with different tools are possible. This also increases the productivity of the transport apparatus.

Favourably, the tool of the tooling unit is formed on the tooling apparatus as a transport tool, whereby another simple transport device, in particular, for removing workpiece parts of the workpiece that have already been machined can be implemented.

Favourably, the tool of the tooling unit is formed on the tooling apparatus as a marking tool, whereby the otherwise elaborate process work step of marking can be implemented in a particularly efficient manner. A position detection on the workpiece, in particular, using the detection unit of the tooling apparatus, is possible in a particularly easy and prompt manner due to the applied marking, as well as a new positioning of a workpiece or a workpiece part that has already been detached can be implemented. Thereby, a marked workpiece or a workpiece part detached from a workpiece can be transported away and another process work step can be carried out on an unmarked workpiece or a workpiece part detached from a workpiece.

Preferably, at least one transport device on a transport device level of the transport apparatus and at least one other transport device on the same or on another transport device level of the transport apparatus are moveably arranged relative to one another on the guide apparatus. Thereby, a spacious working region and a multitude of complex process work steps are made possible with the aid of a plurality of transport devices on a plurality of material machining units within the transport apparatus. Thereby, process work steps running in parallel become capable of being implemented for increasing the productivity and/or cycle times in the transport apparatus.

Preferably, the at least one transport device in the at least one other transport device are moveable relative to one another in an intersecting manner at least in a movement direction, whereby a collision-free movement of the transport devices arranged on the guide apparatus is possible. In this connection, an intersecting movement is understood as being in a largely horizontal direction along the guide apparatus as well as in a largely vertical direction relative to the guide apparatus of the transport apparatus. Thereby, complex process work steps can be implemented, such as loading steps, unloading loading steps, intermediate storage steps, sorting steps, as well as machining steps on one, or a plurality of material machining units in the transport apparatus.

Preferably, at least two transport devices are provided on a common transport device level, whereby a space-saving embodiment can be implemented. Thereby, for example, a transport device is designed as a moveable intermediate storage for unmachined workpieces, which can be filled, for example, by people, from a plurality of sides of the intermediate storage using a crane or with a forklift.

Preferably, at least two transport devices are provided on a common transport device level, wherein this common transport device level is arranged between a transport device level and another transport device level. Thereby, the transport apparatus in this embodiment comprises at least three transport device levels, wherein a plurality of transport devices are moveably arranged at least on one transport device level and at least one transport device comprises a multifunctional tooling apparatus, whereby complex process work steps are carried out in a collision-free manner and production capacity is maximized.

Favourably, at least two transport devices are provided on a common transport device level, wherein this common transport device level is arranged between a transport device level and the at least one material machining unit, whereby a compact transport apparatus can be produced, in particular, for spaces with a low level of design height, which has a very high level of transport capacity and process sequence capacity.

Preferably, at least one transport device is designed as a material storage carriage, whereby, for example, the process sequence time is shortened since, in the case of an ongoing process sequence, no material must be supplied into the transport apparatus from the outside and a plurality of material machining units can be equipped simultaneously.

Favourably, at least one transport device is a tool changing carriage, whereby the tool changing time is reduced since the tool changing carriage is moveable, for example, relative to the tooling unit and thereby, a tool change is made possible at each desired point. Favourably, a tool storage section is arranged on the tool changing carriage for temporarily storing tools, for example, marking tools, wherein, in a particularly favourable embodiment, the tool storage section is moveably arranged relative to the tool changing carriage. Thereby, a particularly time-saving tool change is possible and the downtimes of the transport devices in the transport apparatus are minimized.

Preferably, at least one transport device is a material transport carriage, whereby at least one workpiece is easily transported to the at least one material machining unit.

Favourably, the at least one material transport carriage is a double-fork transport carriage, which is particularly suitable for an easy loading and unloading of workpieces having large areas.

Favourably, the at least one material transport carriage is an aspiration apparatus transport carriage, which can be used for workpieces with different workpiece dimensions. The aspirators of the aspiration apparatus are favourably individually impinged, for example, with a negative pressure, being even more favourable, independently of one another.

Preferably, a workpiece storage section for temporarily storing workpieces, in particular, a stack of workpiece or for temporarily storing at least one tool is arranged on at least one material transport carriage, wherein the workpiece storage section in an alternative embodiment is moveably arranged relative to the material transport carriage, whereby a transport device with a material transport carriage and a workpiece storage section can be used particularly efficiently and at least one process work step can be carried out with the aid of the moveable material transport carriage.

Favourably, the transport device with a workpiece storage section is arranged for storing at least one workpiece or a workpiece part detached from a workpiece or at least one tool on a transport device level, which is arranged between at least one first transport device level and a workpiece holding table of the material machining unit. The first transport device level comprises a moveable transport device in this embodiment, on which, in particular, the at least one multifunctional tooling apparatus is arranged. Thereby, an efficient process work step can be carried out on the material machining unit using the transport device and, simultaneously, a process work step or process step can be carried out on the workpiece storage section of the transport device with the multifunctional tooling apparatus.

In an alternative embodiment, a material carriage is arranged on the same level as the transport apparatus, wherein a separate guide apparatus is provided for this and the material carriage is moveably arranged relative to the transport apparatus. Thereby, an additional material storage level is favourably arranged in the transport apparatus, which, for example, is decoupled from the guide apparatus of the transport apparatus and, being particularly favourable, interacts with the transport apparatus so that the process sequence time is shortened, and productivity is improved. The material carriage is favourably arranged on the industrial plant floor.

In another embodiment, the workpiece storage section is also used for storing tools and the tool storage section is also used to store workpieces or workpiece parts.

Preferably, a least two guide apparatus carriers each with a longitudinal extension are provided to guide at least one transport device in the transport apparatus. Two guide apparatus carriers provide for a stable motion sequence of the transport devices, in particular, if the workpiece has a high net weight on the one hand and is quickly moved from one position in the transport apparatus to another position in the transport apparatus on the other.

Preferably, the guide apparatus carriers are arranged in parallel to the at least one transport device level of the transport apparatus, wherein the statics of the transport apparatus are particularly improved and quick process work steps can be carried out.

Preferably, at least two transport devices are provided, wherein each guide apparatus carrier comprises at least two guide sections for guiding the transport devices, wherein the transport devices can be moved independently of one another on their own transport device levels.

Preferably, at least one of the guide sections is a guide rail section, whereby a particularly easy-to-manufacture guide section can be used, and a precise guiding of the transport devices is given.

Favourable, at least one of the guide sections extends along the longitudinal extension of the guide apparatus carrier, whereby the working region of the transport devices is enlarged.

Favourably, at least one of the guide sections extends along the entire longitudinal extension of the guide apparatus carrier and, thereby, at least one transport device can be moved across the entire transport apparatus and, thereby, reaches all material machining units in the transport apparatus.

Preferably, at least one of the transport devices is arranged hanging on the guide apparatus carriers of the guide apparatus, whereby a space-saving transport movement can be implemented, which, for example, can be used for a transport apparatus with a particularly low level of design height.

In an alternative embodiment, at least one of the transport devices is arranged supported on the guide apparatus carriers of the guide apparatus, wherein a simple and stable transport movement can be carried out.

Preferably, a plurality of carrier supports are provided for carrying the guide apparatus carriers. A plurality of carrier supports increase the basic static strength of the transport apparatus, whereby, in particular, heavy workpieces can be transported with the transport devices as promptly as possible.

Favourably, the at least two carrier supports have a conical shape. Conical carrier supports improve the stability of the transport apparatus and simultaneously reduce the cost of materials for manufacturing the transport apparatus.

Being furthermore favourable, the at least two carrier supports are arranged in a strut-free manner, whereby accessibility to the transport apparatus, for example, for loading and unloading the transport devices using a forklift or by hand by a person is increased independently of the current process work step in the transport apparatus.

Being furthermore favourable, the at least two carrier supports are connected to at least one guide apparatus carrier, whereby the stability of the transport apparatus is additionally improved.

Favourably, a plurality of carrier supports are directly connected to at least one guide apparatus carrier, whereby, favourably, an improved stability of the entire transport apparatus is achieved.

The method according to the invention for loading and unloading of at least one material machining unit with the previously presented transport apparatus is characterized by the following steps.

Preferably, the loading (step a) of at least one material machining unit with a workpiece with at least one of the transport devices.

Then, the unloading (step b) of the workpiece or at least one workpiece part detached from a workpiece from the material machining unit takes place using at least one of the transport devices and, simultaneously, a process work step is carried out on another workpiece or at least one workpiece part detached from a workpiece part using another transport device.

Thereby, a complex process sequence with a previously described transport apparatus can be produced in a simple and inexpensive manner and productivity in an industrial plant is increased. Complex process sequences, which could not be carried out using the transport apparatuses known from the most recent background art can now be implemented with the previously described transport apparatus in a collision-free manner, wherein the workpiece must not leave the transport apparatus. Thereby, an increased productivity is achieved by reducing the number of downstream (mostly manual) process work steps and/or process steps in the transport apparatus in addition to achieving a low level of downtime in the at least one material machining unit in the transport apparatus.

Thereby, the method can a method for operating a transport apparatus. The method can also be designed as a method for controlling and/or regulating a transport apparatus. In the case of regulation, the detected process parameters are taken into account and calculated.

Favourably, the unloading of the at least one material machining unit takes place with the at least one tooling apparatus, whereby, for example, the workpiece parts detached from a workpiece can be removed from the material machining unit in a particularly time-saving and material-preserving manner.

Preferably, at least one tool of the at least one multifunctional tooling apparatus carries out a process work step on the workpiece or at least on a workpiece part detached from a workpiece before loading the workpiece or at least one workpiece part detached from a workpiece into the material machining unit. For example, the tool of the tooling apparatus marks the workpiece or at least one workpiece part detached from a workpiece in order to locate the marked point after another process work step again, such as, for example, a possibly necessary new positioning of the workpiece with the tooling unit.

Preferably, the at least one multifunctional tooling apparatus carries out a tool change on at least one tooling unit of the tooling apparatus or on at least one tooling unit of another tooling apparatus while loading the workpiece or at least one workpiece part detached from a workpiece onto the material machining unit or it changes to another tooling unit of the tooling apparatus. Thereby, in addition to the process work steps on the workpiece, process steps, such as a tool change, are carried out, which minimize the time effort during entire process sequence and increase productivity since at least the process step of the tool change can take place directly on the same position in the transport apparatus.

Preferably, at least one intersecting transport movement of at least one transport device is carried out on a first transport device level with one of the transport devices on another transport device level during the unloading of the workpiece or of at least one workpiece part detached from a workpiece from the material machining unit, whereby the transport devices can carry out collision-free and complex process sequences across a large working region on the various transport device levels. As an alternative, intersecting transport movements of the transport devices are carried out on the same or on different transport device levels collision-free manner, which run vertically to at least one of the transport device levels, whereby the transport capacity is improved in the transport apparatus.

Preferably, the detection unit of the at least one tooling apparatus detects a process parameter and saves this into a memory while unloading the workpiece or at least one workpiece part detached from a workpiece from the material machining unit. Thereby, it has proven to be favourable that the process parameter can be repeatedly called up from the memory and, thereby, the same process work steps can be carried out in a highly precise embodiment on different workpieces several time and automatically.

Preferably, another material machining unit is loaded with another workpiece or with at least one workpiece part detached from another workpiece during the unloading of the workpiece or of the at least one workpiece part detached from a workpiece from the material machining unit, whereby process work steps take place in parallel on a plurality of workpieces and, thereby, productivity is increased with the aid of the transport apparatus.

Preferably, a tool of the at least one tooling apparatus of the at least one transport device on a first transport device level carries out a process work step on a workpiece or on at least one workpiece part detached from another workpiece, which is located on another transport device of a favourably other transport device level. Thereby, a process work step can be carried out on a transport device directly next to the material machining unit, whereby a time-saving machining on the workpiece is implemented. Furthermore, a tool change is also possible on an adjacent transport device level. Favourably, the previously described method step is possible at any time in parallel, in particular, while the at least one material machining unit is loaded or unloaded by another transport device.

Preferably, the at least one tooling apparatus carries out a tool change on at least one tooling unit of the tooling apparatus or on at least one tooling unit of another tooling apparatus while unloading the workpiece or at least one workpiece part detached from a workpiece from the material machining unit or it changes to another tooling unit of the tooling apparatus. Thereby, in addition to the process work steps on the workpiece, process steps, such as a tool change, are carried out, which minimize the time effort during the process sequence and considerably increase productivity.

Preferably, the at least one tooling apparatus carries out another process work step on the workpiece or on at least one workpiece part detached from a workpiece after unloading the workpiece or at least one workpiece part detached from a workpiece from the material machining unit, whereby increased productivity is achieved. Preferably, a sorting step or a storing step is carried out, whereby, in addition to a process work step on the workpiece, other different process work steps, such as sorting or storing for example, are carried out, which minimize the time effort of the process sequence and increase productivity.

A computer program product according to the invention, which detects at least one process parameter of the loading process and the unloading process after the loading into a memory of a control device with a detection unit, then causing one of the previously described methods for loading and unloading using the transport apparatus, wherein the process sequences can be programmed and be stored in the memory in advance. Thereby, a fully automated transport apparatus can be implemented for loading and unloading at least one material machining unit. The computer program product can comprise a computer program for carrying out the method for controlling and/or regulating the transport apparatus. The computer program can, as is described in the above, be loaded into a memory of a control device. As an alternative, the computer program can also be loaded directly into a unit of the transport apparatus and/or executed there. The transport apparatus can be electrically controlled and/or regulated. The computer program can be an integral part of an embedded system. The computer program can be read in and/or provided via an interface from a central instance (e.g. server) locally on the transport apparatus as an executable program code.

Other advantages, features and details of the invention result from the following description, in which exemplary embodiments of the invention are described, taking the drawings under consideration.

The reference list is an integral part of the disclosure like the technical content of the patent claims and figures are. The figures are comprehensively described in relation to one another. Identical reference numbers denote identical components, and reference characters having different indices indicate functionally identical or similar components.

The figures show:

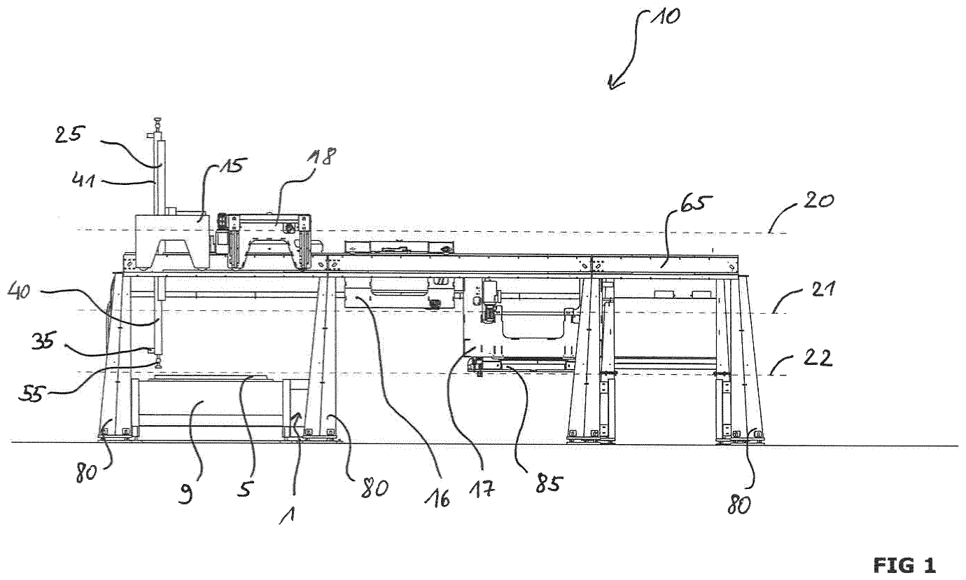

FIG. 1 a first embodiment of a transport apparatus according to the invention in a lateral view;

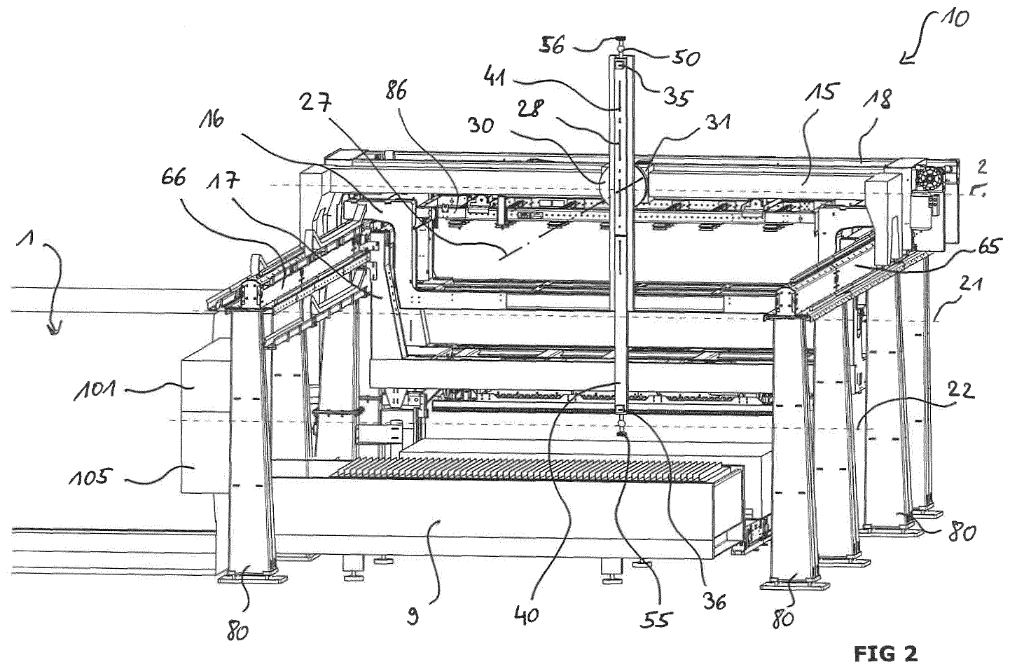

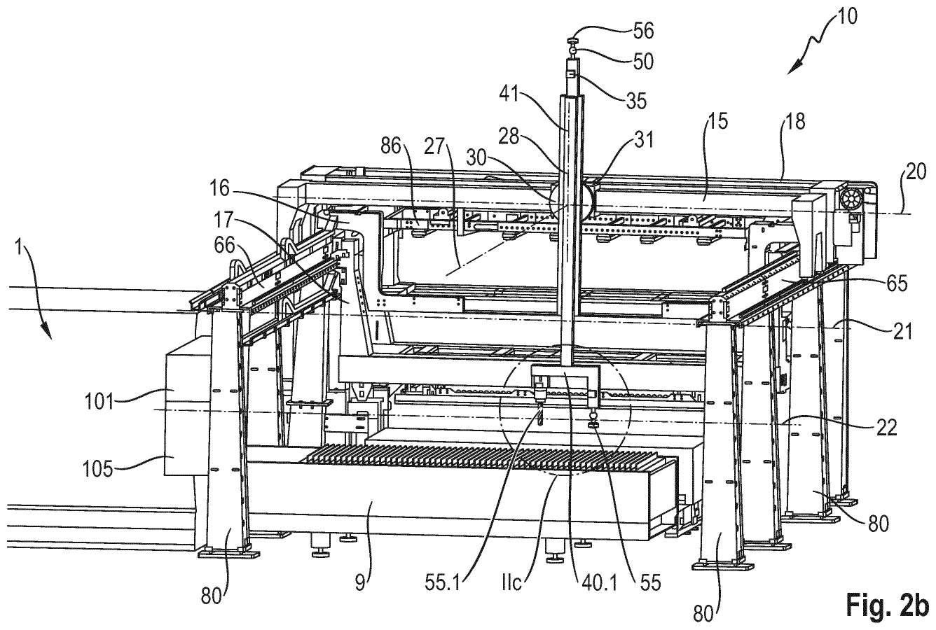

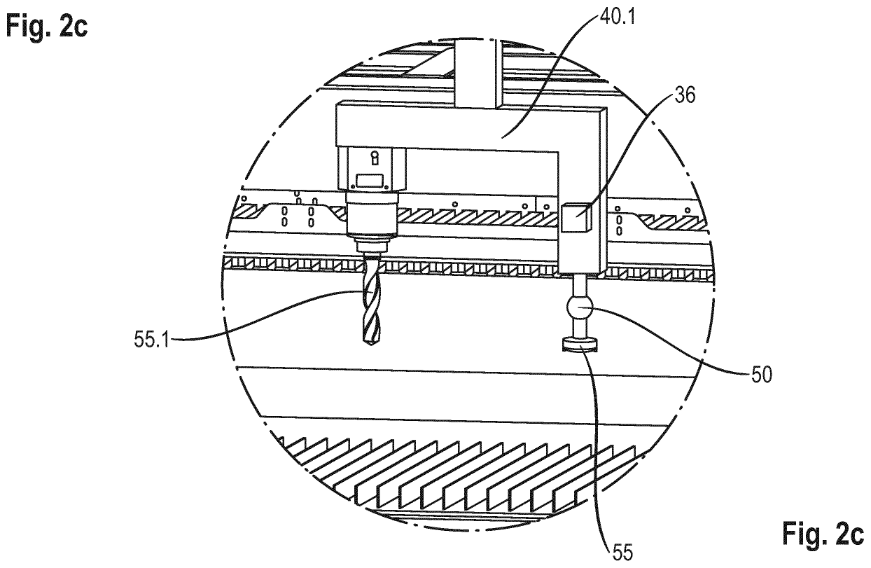

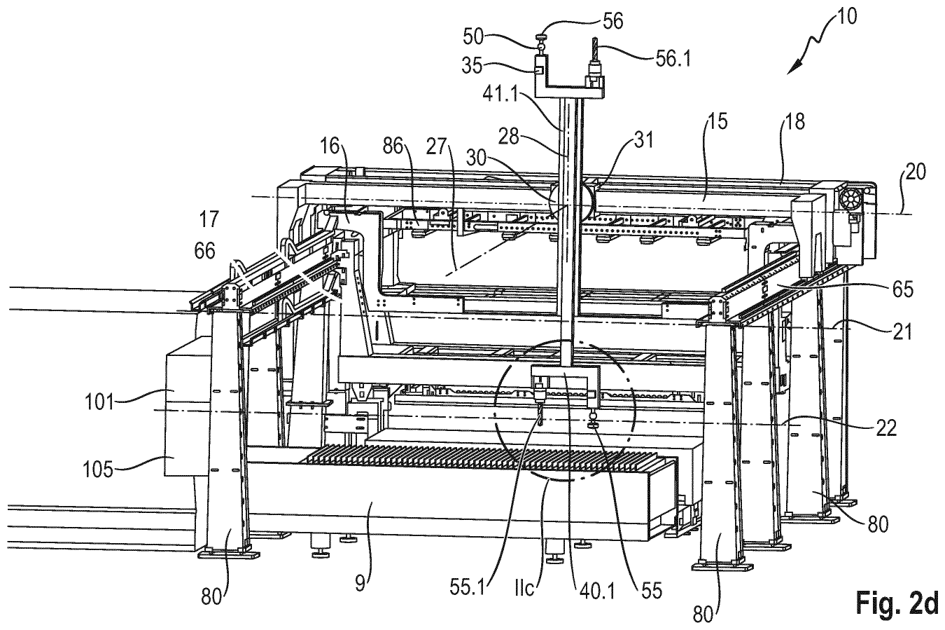

FIG. 2 the transport apparatus according to the invention in FIG. 1 in another lateral view;

FIG. 2b another transport apparatus according to the invention in a lateral view analogous to FIG. 2;

FIG. 2c an enlarged view of a section of the transport apparatus in accordance with the marking IIc in FIGS. 2b and 2d.

FIG. 2d another transport apparatus according to the invention in a lateral view analogous to FIGS. 2 and 2b;

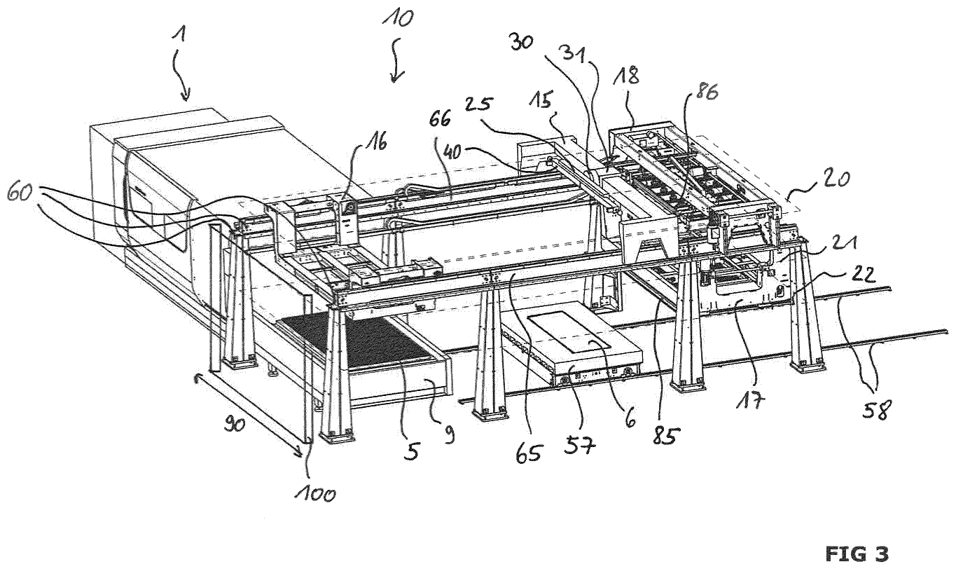

FIG. 3 a perspective view of a transport apparatus according to the invention in accordance with FIG. 1;

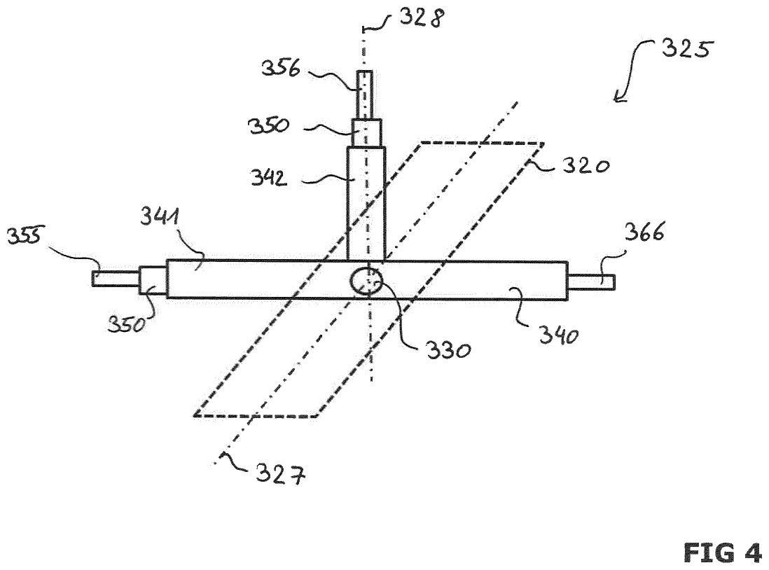

FIG. 4 a schematic illustration of a tooling apparatus complete with tooling units;

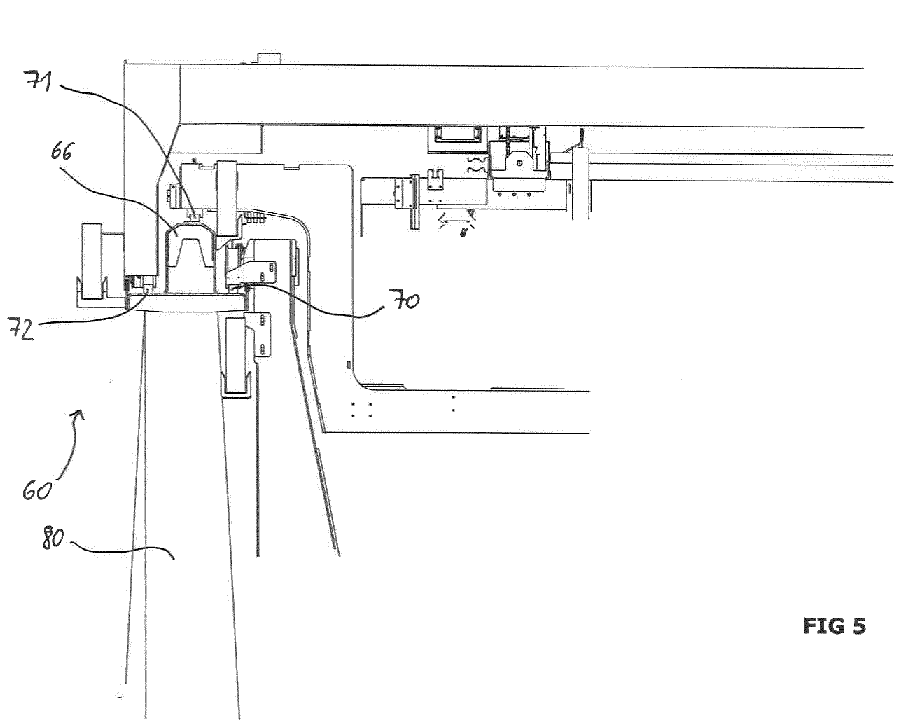

FIG. 5 a cross section of a guide apparatus;

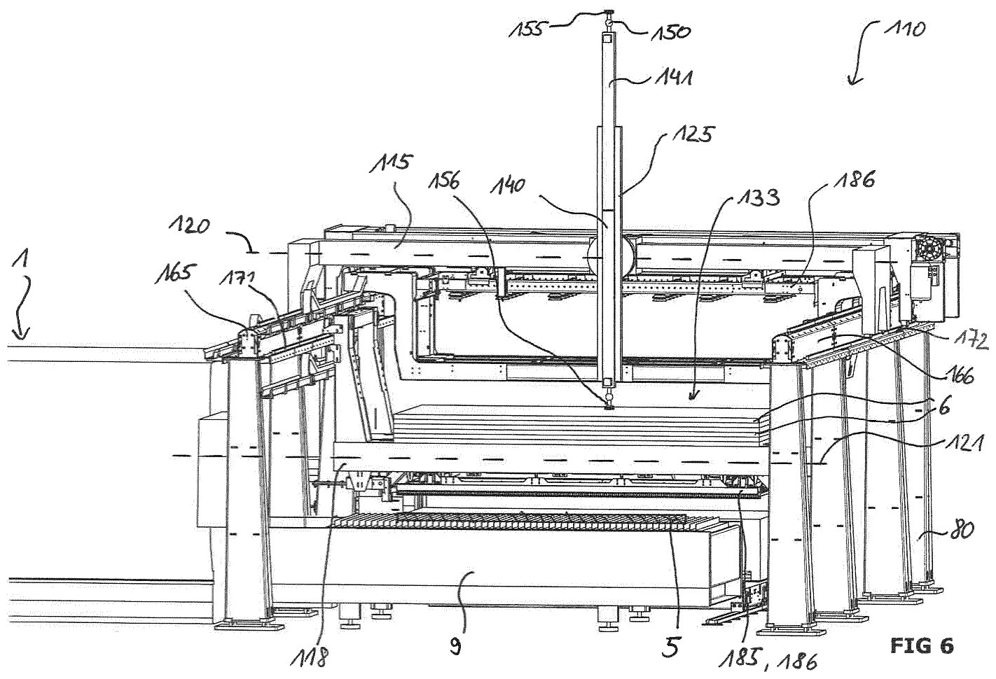

FIG. 6 a lateral view of another embodiment of a transport apparatus according to the invention;

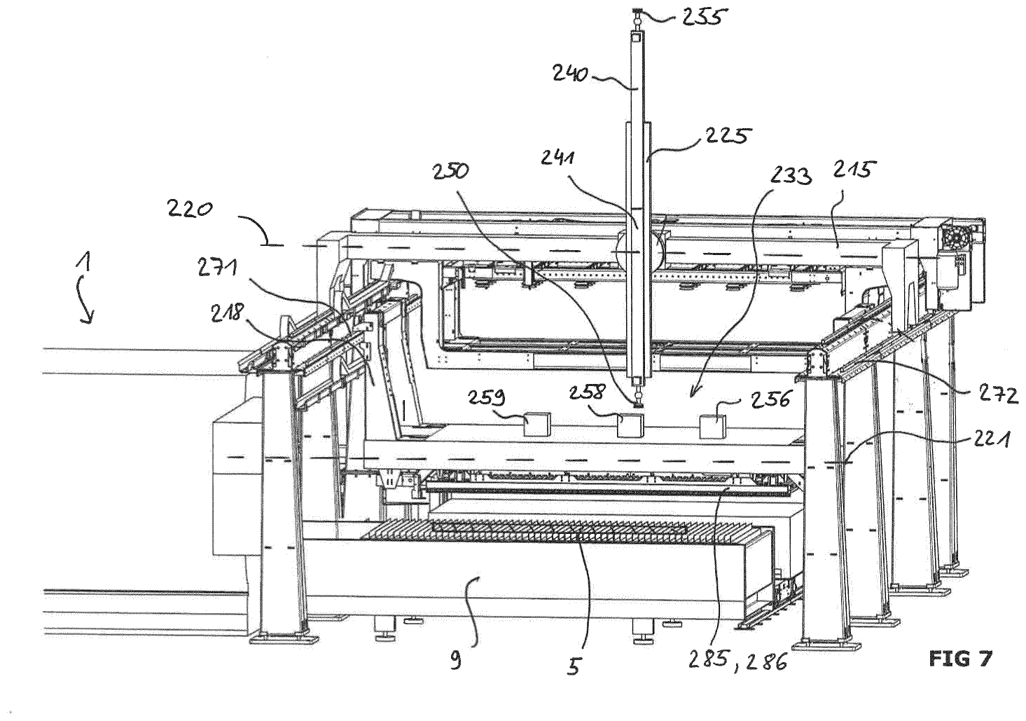

FIG. 7 a lateral view of another embodiment of a transport apparatus according to the invention; and

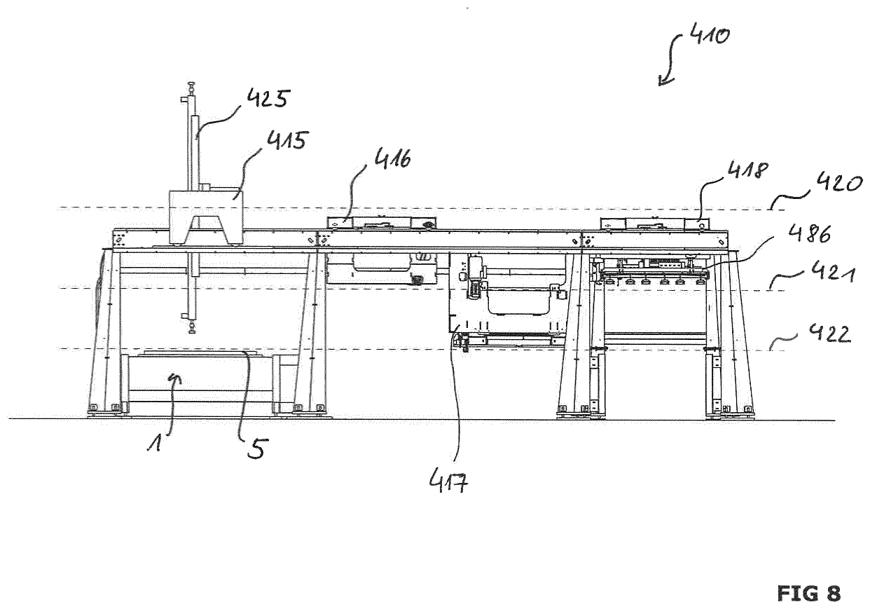

FIG. 8 a lateral view of another embodiment of the transport apparatus according to the invention in accordance with FIG. 1.

FIGS. 1 to 3 show the transport apparatus 10 according to the invention for loading and unloading a material machining unit 1 with at least one workpiece 5 or a workpiece part 7 detached from a workpiece 5. In this embodiment, the material machining unit 1 is a laser cutting machine with a moveable workpiece holder, for example, with a moveable workpiece holding table 9. It is to be understood that the workpiece and the workpiece part is not part of the transport apparatus 10.

The transport apparatus 10 comprises a guide apparatus 60, with two guide apparatus carriers 65, 66 and a plurality of carrier supports 80, which bear the guide apparatus carriers 65, 66. The transport apparatus 10 additionally comprises a plurality of transport devices 15, 16, 17, 18, which are arranged on the guide apparatus 60. At least two of the transport devices 15, 16, 17, 18 are moveably arranged relative to one another in the transport apparatus 10.

The transport devices 15 and 18 are arranged on a first transport device level 20 and another transport device 16 is arranged on another transport device level 21. The transport device 15 comprises a moveable multifunctional tooling apparatus 25, which is designed for transporting and/or machining the workpiece 5 or the workpiece part 7. In this connection, the term workpiece 5 (not exhaustive) is referred to as an unmachined plate-shaped workpiece with a large area, for example, a raw metal sheet or a glass plate, as well as a workpiece that has already been machined, such as a semi-finished product or a sheet skeleton. In this connection, under the term workpiece part 7. a part of a workpiece 5 is understood.

The transport devices 15, 16, 17, 18 of the transport apparatus 10 are also suitable in order to transport or machine other workpiece shapes, such as cube-shaped, sphere-shaped, or also trapeze-shaped workpieces.

As is shown in FIG. 5 in detail, the guide apparatus carrier and 66 of the guide apparatus 60 each comprise a longitudinal extension and are arranged in parallel to the transport device level 20 of the transport apparatus 10. Furthermore, the guide apparatus carriers 65 and 66 of the guide device 60 are arranged in parallel to one another. Each guide apparatus carrier 65 and 66 comprises three guide sections 70, 71, 72, on which the transport devices 15, 16, 17, 18 are guided. The guide sections 70, 71, 72 are each designed as guide rail sections and extend along the entire longitudinal extension of the respective guide apparatus carrier 65 and 66 in this exemplary embodiment.

As can be recognized in FIG. 2, transport devices 16 and 17 are arranged in a manner hanging on guide apparatus carriers 65 and 66. The transport apparatuses 15 and 18 are arranged in a supporting manner on the guide apparatus carriers 65 and 66.

The carrier supports 80 to carry the guide apparatus carriers 65 and 66 are conical and free of struts and are directly connected to the guide apparatus carriers 65 and 66. In an alternative embodiment (not shown here), the carrier supports 80 can be connected to guide apparatus carriers 65 and 66 via a connecting piece.

The multifunctional tooling apparatus 25 in this embodiment shown is arranged on the transport device 15 in a pivotable, rotatable and linearly moveable manner. The tooling apparatus 25 can be moved along a straight line relative to the transport device 15, in particular, perpendicularly. The tooling apparatus 25 is additionally pivotable and rotatable around an axis 27, which is orientated in parallel to one of the transport device levels 20, 21, 22 of the transport apparatus 10, as well as pivotable and rotatable around another axis 28, which is orientated normally to one of the transport device levels 20, 21, 22 of the transport apparatus 10. Furthermore, the tooling apparatus 25 can be arranged along at least one of the axes in a linearly moveable manner. Here, the tooling apparatus 25 is arranged in a linearly moveable manner along the transport device 15.

A first movement apparatus 30, which connects the tooling apparatus 25 and the transport device 15 makes a linear movement of the tooling apparatus 25 along a first straight line possible and is, for example, designed as a telescopic arm. The first movement apparatus 30 comprises an electrical, mechanical, hydraulic or pneumatic drive system (not shown) for example. Furthermore, the movement apparatus 30 is designed as a pivoting device, wherein the tooling apparatus 25 is, in part or as a whole, rotated out of the transport device level 20. Furthermore, the movement apparatus 30 is designed as a pivoting apparatus in order to pivot the tooling apparatus 25, in part or as a whole, out of the transport device level 20. Furthermore, the movement apparatus 30 is designed in order to carry out one of the combinations of a linear movement and a rotational movement, a linear movement and a pivoting movement, a rotational movement and a pivoting movement, as wells as a linear movement, a rotational movement and a pivoting movement.

Thereby, transport steps as well as machining steps, such as the drilling of a bore hole through the workpiece 5, can also be carried out outside of the perpendicular of the transport device levels and also outside of a vertical running relative to the workpiece surface.

In an alternative embodiment, the multifunctional tooling apparatus 25 comprises a movement device, which is arranged between at least one end of the tooling unit 40 and the tool 55 (not shown).

The transport device 15 and the tooling apparatus 25 comprise at least one other movement apparatus 31, which makes a movement of the tooling apparatus 25 along the transport device 15 possible. Thereby, this movement apparatus 31 comprises a guide system and is designed with an electrical, mechanical, hydraulic or pneumatic drive system. In an embodiment (not shown here), the first movement device 30 and the movement apparatus 31 can be integrated into one another.

The multifunctional tooling apparatus 25 is designed in order to carry out at least one process work step or a process step on one of the transport device levels 20, 21, 22 or on a workpiece 5, for example, on the tool holding table 9 of the material machining unit 1 without the tooling apparatus 25 colliding with the transport devices 15, 16 and 17.

In this embodiment, the multifunctional tooling apparatus 25 comprises two tooling units 40 and 41 for machining and/or transporting a workpiece 5 or a workpiece part 7. The tooling units 40 and 41 are (for example, by means of a telescopic arm drive as a movement apparatus (not shown)) are moveable relative to one of the transport devices 16, 17 and 18 in order to machine or to transport a workpiece 5 or a workpiece part 7. Thereby, the workpieces 5 or the workpiece parts 7, which are located on another transport device level 21 and or on the workpiece holding table 9 of the material machining unit 1, can be machined using a tool 56 of the tooling unit 41, in particular, marking, mechanical machining or other process work steps. In the embodiment shown, a change is made from a tooling unit 40 to the other tooling unit 41 via a rotational movement by means of the movement apparatus 30. In addition to the described rotational movement, other movement sequences are still possible for the tooling unit change, such as a pivoting movement or a linear movement.

The tooling unit 40 comprises a tool 55, which is, for example, an aspiration apparatus for transporting a workpiece 5. The other tooling unit 41 comprises another tool 56, which is a drilling tool for example. The tooling unit 41 comprises a tool holding unit 50, by means of which the tool 56 is held.

At least one of the tooling units 40, 41 comprises means to drive a workpiece 55, 56 or to support the functionality of a workpiece 55, 56. For example, such a means comprises a mechanical gearbox, a fluid supply or a drive means.

As tools 55 and 56 for carrying out a process work step, in general, a manufacturing tool is understood, for example a drill, a milling tool, a thread cutter, a deburring tool or a forming tool. Furthermore, under this term, a stamping tool, a centre-punch tool, a punching tool, a cold-forming tool, a chamfering tool, a scribing tool, a glue nozzle or a separation tool is also understood. Other examples include a mechanical cutting tool or a coating tool, for example, a painting tool, a lubrication tool or a generative manufacturing tool, for example a laser cutting tool, a laser sintering tool, a stud-welding tool, a cleaning tool or a transport tool. Additional examples include an aspiration apparatus, a gripping apparatus, a printing unit four labelling, a labelling tool or a marking tool, for example a laser marking tool or a marking needle.

The tools can also be designed as oil dispensers or as oil dispenser nozzles or also as a degreasing device.

The aforementioned tools do not comprise an exhaustive list, since no other tools can be arranged on the tooling apparatus 25 for machining or transporting.

The transport devices 15 and 16 are moveably arranged relative to one another on the guide apparatus 60. Thereby, transport devices 15 and 16 can be moved at least in a movement direction relative to one another in an intersecting manner. The other transport device 18 is moveably arranged on the transport device level 20 and can be moved in a movement direction relative to the transport device 16 in an intersecting manner.

The multifunctional tooling apparatus 25 comprises detection unit 35 or a detector 36 for detecting a process parameter. The detection unit 35 is arranged right next to the tooling unit 40 or is arranged on a point, which is at a distance away from the tooling unit 40. The detection unit 35 is designed as a camera, for example a video camera, or as a detector 36, which detects electromagnetic radiation or, for example, a barcode or a QR code, or as a mechanical detection unit, for example, a pushbutton sensor.

Process parameters comprise parameters describing the workpiece 5 or the workpiece part 7 detached from the workpiece, such as their weight, their geometric shape and size, their cutting-edge parameters, their material, their surface quality as well as parameters, which describe the movement in the transport apparatus, such as the movement speed of one or a plurality of transport apparatuses.

The detection unit 35 detects the exact position of the workpiece 5 or of the workpiece part 7 and guides the tooling apparatus 25 or the tools 55 and 56 arranged on the tooling units 40 and 41 to the workpiece position defined in advance during the process sequence in order to then carry out at least one other process work step on the workpiece 5 or the workpiece part 7.

As an alternative, the at least one multifunctional tooling apparatus 25 or another multifunctional tooling apparatus is arranged for machining and/or transporting a workpiece or workpiece part on the other transport device levels 21 or 22. Furthermore, as an alternative, in other transport device, for example, an aspiration apparatus transport carriage 86 or a double-fork transport carriage 85 is arranged on the first transport device level 20.

In FIGS. 2b and 2c, another transport apparatus according to the invention for loading and unloading a material machining unit 1 is shown. This transport apparatus 10 differs from the transport apparatus 10 described with reference to the FIGS. 1, 2, and 3 to 8 due to the fact that the multifunctional tooling apparatus in this embodiment comprises a tooling unit 40.1 for machining and transporting of a workpiece 5 or of a workpiece part 7 and a tooling unit 41 for transporting a workpiece 5 or a workpiece part 7. In turn, the tooling units 40.1 and 41 are (for example, by means of the previously mentioned telescopic arm drive as a movement apparatus (not shown)) are moveable relative to one of the transport devices 16, 17 or 18. The tooling unit 40.1 comprises a fork-shaped or U-shaped end, on which, a tool 55 designed as an aspiration apparatus for transporting a workpiece 5 is arranged on a fork end. Another tool 55.1 designed as a drilling tool is arranged on another fork end. The other tooling unit 41 comprises another workpiece 56, which, for example, is another aspiration apparatus for transporting a workpiece 5. As an alternative however, a different type of tool can be arranged there. With respect to other reference numbers not explicitly mentioned here, reference is fully made to the description of FIGS. 1, 2 and 3 to 8.

In FIG. 2d, another transport apparatus 10 according to the invention for loading and unloading a material machining unit 1 is shown, which differs from the transport apparatus shown in FIG. 2b in that both tooling units 40.1 and 41.1 comprise a fork-shaped or U-shaped end there. With respect to other reference numbers not explicitly mentioned here, reference is fully made to the description of FIGS. 1, 2 and 3 to 8.

As is described in more detail in FIG. 6 and FIG. 7, the transport device 18 can be designed as a material storage carriage and/or as a tool changing carriage. This tool changing carriage can be combined with a material transport carriage, for example, a double-fork transport carriage 85 or an aspiration apparatus transport carriage 86.

The transport apparatus 10 (see FIG. 2) comprises a control unit 105, which, for its part, comprises a memory 101. The memory 101 stores process parameters among other things, which are detected here by the detection unit 35. The memory 101 stores a computer program product, which carries out a predefined process sequence with the transport devices 15, 16, 17, 18 and the at least one tooling apparatus 25 of the transport apparatus 10 as well as the at least one material machining unit 1 after loading into the memory 101. The individual drive units (for example, motors) of the transport devices 15, 16, 17 and 18, as well as the tooling apparatus 25, however also the material machining unit 1 are electrically connected to one another for transmitting control data and/or process sequence data, such as a process parameter. In another embodiment, the memory for the computer program product is arranged on a computer distance away from the transport apparatus, which is favourably connected to the control device 105.

The material transport apparatus 57 shown in FIG. 3 is moveably arranged on a separate guide apparatus 58. The material transport apparatus 57 is moveable when released from the guide apparatus 60 of the transport apparatus 10.

The guiding mechanism 58 protrudes at least partially into the working region of the transport apparatus 10 and makes a transport of the workpieces 5, 6, or of the workpiece parts 7 into the transport apparatus 10 possible or out of this, as well as in a direction along the longitudinal extension of the guide apparatus carrier 65 of the transport apparatus 10.

On the edge region 90 of the transport apparatus 10, at least one security gate 100 is provided so that unauthorized entry to the transport apparatus 10 is prevented, particularly when it is operating. Thereby, the safety is increased for personnel and work accidents can be prevented. Furthermore, at least one of the transport devices 15, 16, 17, 18, in particular a material storage carriage, favourably becomes accessible to the transport apparatus 10 via the security gate 100 in order to make easy loading or unloading of the transport devices 15, 16, 17, 18 with workpieces 5, 6 possible, for example, using a forklift.

The transport apparatus 10 in accordance with FIGS. 1 to 3 is designed according to the invention in such a way that they can load and unload other material machining units in addition to the first material machining unit 1 with the aid of their transport devices 15, 16, 17, 18, as well as the multifunctional tooling apparatus 25.

In an alternative embodiment, a plurality of transport devices each with at least one multifunctional tooling apparatus are provided in the transport apparatus, which, for example are arranged on a common transport device level and make the transport and/or the machining on or to a plurality of material machining units possible. For example, the number of transport devices each with at least one tooling apparatus corresponds to the number of the material machining units that can be reached by this transport apparatus. By means of this, the other material machining units can be simultaneously supplied with workpieces and/or workpiece parts can be machined, which further improves the process sequence.

In the following, the method according to the invention for loading and unloading the material machining unit 1 with a workpiece 5 or a workpiece part 7 with the transport apparatus 10 is presented.

The loading of at least one material machining unit 1 with a workpiece 5 takes place with one of the transport devices 16, 17, 18, for example, using the aspiration apparatus transport carriage 86 or the double-fork transport carriage 85.

Then, the loading of the workpiece 5 or a workpiece part 7 detached from a workpiece from the material machining unit 1 takes place with the multifunctional tooling apparatus 25, wherein, simultaneously, a process work step is carried out on another workpiece 6 or at least one workpiece part 8 detached from a workpiece using a transport device 15.

As an alternative, one of the transport devices 16, 17, 18, in particular the aspiration apparatus transport carriage 86, takes a workpiece part 7 that is already been machined from the material machining unit 1 during a parallel process work step.

During a parallel process work step, the double-fork transport carriage 85 unloads the sheet skeleton of a machined workpiece 5, for example, from the material machining unit 1 or from another material machining unit.

Furthermore, at least one tool 55, 56 of the tooling apparatus 25 carries out a process work step on the workpiece 5 or on the workpiece part 7 before unloading the workpiece 5 or the workpiece part 7 from the material machining unit 1.

During another method step, the tooling apparatus 25 carries out a tool change on the tooling unit 40 of the tooling apparatus 25 or on at least the tooling unit of another tooling apparatus while loading the workpiece 5 or the workpiece part 7 onto the material machining unit 1. In addition or as an alternative to the aforementioned steps, a change is made to the other tooling unit 41 of the tooling apparatus 25.

The detection unit 35 detects a process parameter during another process step, for example, during unloading and stores this in a memory 101.

As an alternative, an intersecting transport movement is carried out by the transport devices 15 on a first transport device level 20 and by one of the transport devices 16, 17, 18 on another transport device level 21 while unloading the workpiece 5 or the workpiece part 7 from the material machining unit 1. The workpiece apparatus 25, which is arranged on the transport device 15, carries out a linear movement and/or a rotational movement and/or a pivoting movement, which guides the tooling apparatus 25 out of at least one of the transport device levels 20, 21, 22. Thereby, a collision between one of the transport devices 15, 16, 17, 18 and the tooling apparatus 25 is ruled out.

Furthermore, another material machining unit is loaded with another workpiece 6 or with at least one workpiece part 8 detached from another workpiece 6 during the unloading of the workpiece 5 or of the workpiece part 7 from the material machining unit 1, whereby, favourably, process work steps take place in parallel and fully automatically on a plurality of workpieces 5 and 6 or workpiece parts 7 and 8. The loading preferably takes place using one of the double-fork transport carriages 85 or one of the aspiration apparatus transport carriages 86.

Furthermore, the tools 55, 56 of the tooling apparatus 25 on the transport device 15 from a first transport device level 20 carry out a process work step on a workpiece 6 or on a workpiece part 8, which is located on another transport device 18 on another transport device level 21. Favourably, the process work step is carried out on a transport device 18 directly next to the material machining unit 1, whereby a time-saving machining on the workpiece 6 is implemented. Favourably, a tool change can also be carried out on an adjacent transport device level. This method step can be carried out at any time before, during and after loading or unloading the material machining unit 1.

Furthermore, the at least one tooling apparatus 25 carries out a tool change on at least one tooling unit 40 of the tooling apparatus 25 or on at least one tooling unit of another tooling apparatus while unloading the workpiece or the workpiece part 7 from the material machining unit 1. Being furthermore favourable, the tooling apparatus 25 changes to another tooling unit 41 of the tooling device 25.

The tooling apparatus 25 carries out another process work step on the workpiece 5 or on the workpiece part 7 after unloading the workpiece 5 or the workpiece part 7 from the material machining unit 1. Preferably, thereby, a sorting section or a mounting step is carried out. Favourably, other different process work steps, such as sorting or storing for example, are carried out simultaneously at one process work step on the workpiece.

Before the automatic or programmable process sequence starts, at least one of the transport devices 15, 16, 17, 18, in particular the transport device 16 designed as a material storage carriage, is filled with a stack of workpieces 5, 6, in particular, using a forklift, a crane or by hand by the operator.

In another embodiment, the transport apparatus 10 is connected to a large-scale workpiece storage and the workpieces 5, 6 are favourably supplied by means of a separate rearrangement apparatus into the transport apparatus 10 in a fully automatic manner. (Not shown).

In the following, the computer program product according to the invention for loading and unloading at least one material machining unit 1, in particular, a laser cutting machine or a fluid-jet cutting machine or a water-jet cutting machine, with at least one workpiece 5 or with at least one workpiece part 7 detached from a workpiece according to the method according to the invention with a transport apparatus 10.

The computer program product 109 triggers one of the previously described methods for loading and unloading using the transport apparatus 10 after loading into the memory 101 of the control device 105 and processing of at least one process parameter of the loading process and unloading process, which was detected by a detection unit of the transport apparatus 10 (e.g. the detection unit 35) or of an external detection unit.

FIG. 4 shows another embodiment of a multifunctional T-shaped tooling apparatus 325 with three tooling units 340, 341 and 342. Furthermore, here, the orientations of the axes 327, 328 are shown with reference to a transport device level 320. The tooling units 341, 342 each show a tool holding unit 350 for alternately holding different tools 355 and 356. The tooling apparatus 325 is arranged around a first axis 327 in a pivotable, moveable and/or rotatably moveable manner. The first axis 327 is arranged in parallel to the transport device level 320. The tooling apparatus 325 can thereby additionally assume any orientation relative to the second axis 328. The tooling apparatus 325 can also be moved around the second axis 328 in a rotatable and/or pivotable manner, which is arranged here normally to the transport device level 320. The axis 328 can also be inclined by an angle relative to the transport device level 320.

In another equivalent embodiment, the tooling apparatus 325 is linearly moveable along at least one of the axes 327, 328 or, in addition to a linear movement, is moveably or pivotably arranged around at least one of the axes 327, 328.

The movements of the tooling apparatus 325 can be carried out due to the movement device 330, which connects the tooling device 325 and one of the transport devices. The movement device 330 is arranged with a first movement device part on the tooling apparatus 325 and arranged on the related transport device with a correspondingly shaped counterpart piece. The counterpart piece is preferably designed as a guide rail and favourably continues to extend along the entire transport device.

FIG. 6 shows the transport apparatus 110 according to the invention, which loads and unloads a material machining unit 1 using a workpiece holding table 9. The transport device 118 is arranged on the transport device level 121. The transport device 118 is designed as a workpiece storage carriage and as a material transport carriage and is moveable along the guide apparatus carriers 165, 166. A workpiece storage section 133 for storing workpieces 6 is arranged in a region of this transport device 118. The workpiece storage section 133 is favourably moveably arranged relative to this independently of the moveable transport device 118. A double-fork device 185 or an aspiration apparatus 186, which can be moved perpendicularly to the transport device movement, is arranged in another region of the transport device 118, which can favourably be moved perpendicularly to the transport device level 121. A transport device 115 with a moveable multifunctional tooling apparatus 125 is located on another transport device level 120. The tooling apparatus 125 is designed to carry out at least one process work step on the workpieces 5 on the workpiece storage section 133 in a collision-free manner. In this embodiment, the tooling apparatus 125 comprises a tooling unit 140 with a tool 156 as well as a tooling unit 141, on which another tool 155 is arranged over a tool holder 150. The transport devices 115 and 118 are arranged over two guide sections 171, 172 provided on the guide apparatus carriers 165, 166 hanging or being supported on the guide apparatus carriers 165, 166 and guided by these.

FIG. 7 shows a transport apparatus 210. The transport device 218 is arranged on the transport device level 221 and is designed as a tool changing carriage and as a material transport carriage. The transport device 218 can be moved along the guide apparatus carriers 265, 266. Thereby, a tool storage section 233 for storing tools 256, 258, 259 are arranged in a region of the transport device 218. The tool storage section 233 is favourably moveably arranged relative to this independently of the moveable transport device 218. A double-fork device 285 that can favourably be moved perpendicularly to the transport device movement or an aspiration apparatus 286 that can be moved perpendicularly to the transport device movement is also arranged in another region of the moveable transport device 218. Favourably, a tool change can be carried out in a first region of the transport apparatus 210 and a loading or unloading of the material machining unit 1 can be carried out in another region of the transport apparatus 210 with only the transport device 218. A transport device 215 with a moveable multifunctional tooling apparatus 225 is located in another transport device level 220. The tooling apparatus 225 is designed in order to carry out a process step, for example, a tool change to the workpiece storage section 233 in a collision-free manner. The transport devices 215 and 218 are arranged over two guide sections 271, 272 provided on the guide apparatus carriers 265, 266 hanging or being supported on the guide apparatus carriers 265, 266 and guided by these.

The transport device 115 in accordance with FIG. 6 on the transport device level 120 as well as the transport device 215 in accordance with FIG. 7 on the transport device level 220 are designed in such a way that each can be synchronously moved along the guide apparatus carrier 165, 166 or 265, 266 with the other transport device 118 or 218 and, thereby, the process sequence can be carried out on the or with both transport devices 115, 118 or 215, 218 simultaneously.

FIG. 8 shows an alternative transport apparatus 410 according to the invention. The transport apparatus 410 differs from the previously presented embodiments due to the fact that another transport device 418 is provided on the transport device level 421 in addition to a first transport device 416. The transport devices 415, 416 and 418 are moveably arranged relatively to one another on the guide apparatus 460. Thereby, the transport device 415, which comprises the multifunctional tooling apparatus 425, and the transport device 416 are at least moveable relative to one another in an intersecting manner at least in a movement direction. The other transport device 418 can be moved in a movement direction relative to the transport device 415 in an intersecting manner. In the embodiment shown, the transport device level 421 is arranged between transport device level 420 and the other transport device level 422. Two transport devices 416 and 418 on the transport device level 421 increase the transport flexibility of the transport apparatus 410. The transport device 418 comprises an aspiration device transport carriage 486, which can load or unload either the material machining unit 1 or the transport device 417 with a workpiece 5 or a workpiece part detached from a workpiece. The tooling apparatus 425 can carry out a tool change on the transport device 416 simultaneously.

### REFERENCE LIST

1 material machining unit
2 other material machining unit
5 workpiece
6 other workpiece
7 workpiece part
8 other workpiece part
9 workpiece holding table
10 transport apparatus
15 1^{st} transport device
16 2^{nd} transport device
17 3^{rd} transport device
18 4^{th} transport device
20 1^{st} transport device level
21 2^{nd} transport device level
22 3^{rd} transport device level
25 multifunctional tooling apparatus
27 axis
28 axis
30 1^{st} movement apparatus
31 other movement apparatus
35 detection unit
36 detector
40 1^{st} tooling unit
41 2^{nd} tooling unit
40.1 other 1^{st} tooling unit
41.1 other 2^{nd} tooling unit
50 tool holding unit
55 tool
55.1 tool
56 tool
56.1 tool
57 material transport device
58 guide apparatus of the material transport device
60 guide apparatus of the transport apparatus
65 1^{st} guide apparatus carrier
66 2^{nd} guide apparatus carrier
70 1^{st} guide section
71 2^{nd} guide section
72 3^{rd} guide section
80 carrier support
85 double-fork transport carriage
86 aspiration apparatus transport carriage
90 edge region
100 security gate
101 memory
105 control unit
109 computer program product
110 transport apparatus
115 1^{st} transport device
118 2^{nd} transport device
120 1^{st} transport device level
121 2^{nd} transport device level
125 multifunctional tooling apparatus
133 workpiece storage section
140 1^{st} tooling unit
141 2^{nd} tooling unit
150 tool holding unit
155 tool
156 tool
165 1^{st} guide apparatus carrier
166 2^{nd} guide apparatus carrier
171 1^{st} guide section
172 2^{nd} guide section
185 double-fork transport carriage
186 aspiration apparatus transport carriage
210 transport apparatus
215 1^{st} transport device
218 2^{nd} transport device
220 1^{st} transport device level
221 2^{nd} transport device level
225 multifunctional tooling apparatus
233 workpiece storage section
240 1^{st} tooling unit
241 2^{nd} tooling unit
250 tool holding unit
255 tool
256 tool
258 tool
259 tool
265 1^{st} guide apparatus carrier
266 2^{nd} guide apparatus carrier
271 1^{st} guide section
272 2^{nd} guide section
285 double-fork transport carriage
286 aspiration apparatus transport carriage
320 transport device level
325 multifunctional tooling apparatus
327 axis
328 axis
330 1^{st} movement apparatus
340 1^{st} tooling unit
341 2^{nd} tooling unit
342 3^{rd} tooling unit
350 tool holding unit
355 tool
356 tool
366 tool
410 transport apparatus
415 1^{st} transport device
416 2^{nd} transport device
417 3^{rd} transport device
418 4^{th} transport device
420 1^{st} transport device level
421 2^{nd} transport device level
422 3^{rd} transport device level
425 multifunctional tooling apparatus
486 aspiration device transport carriage

1. A transport apparatus for loading and unloading at least one material machining unit, comprising: a laser cutting machine or a fluid-jet cutting machine, with at least one workpiece or with at least one workpiece part detached from a workpiece comprising a guide apparatus, a plurality of transport devices, which are arranged on the guide apparatus, wherein one of the transport devices is arranged on a first transport device level and comprises at least one moveable tooling apparatus, wherein, at least two other transport device levels are provided, on which at least one of the other transport devices is arranged, as well as the at least one tooling apparatus being multifunctionally designed for transporting or machining the workpiece or at least one workpiece part detached from a workpiece, wherein at least one transport device on a transport device level of the transport apparatus and at least one other transport device on the same or another transport device level of the transport apparatus are moveably arranged relative to one another on the guide apparatus, and wherein the at least one transport device and the at least one other transport device are moveable at least in a movement direction relative to one another in an intersecting manner and at least in two movement directions.

2. The transport apparatus according to claim 1, wherein the at least one tooling apparatus is arranged on the at least one transport device in a pivotable or rotatable or linearly moveable manner and being moveable along the at least one transport device.

3. The transport apparatus according to claim 1, wherein the at least one tooling apparatus comprises at least one tooling unit for machining or transporting a workpiece or at least one workpiece part detached from a workpiece, and wherein the at least one tooling unit is favourably moveable relative to one of the transport device levels.

4. The transport apparatus according to claim 1, wherein the at least one tooling apparatus comprises at least one other tooling unit for machining or transporting a workpiece or at least one workpiece part detached from a workpiece.

5. The transport device according to claim 2, wherein at least one tooling apparatus is rotatable or pivotable around an axis which is orientated in parallel to one of the transport device levels of the transport apparatus or the tooling apparatus is pivotable or rotatable around another axis which is orientated normally to one of the transport device levels of the transport apparatus or is arranged along at least one of the axes in a linearly moveable manner.

6. The transport apparatus according to one claim 1, wherein the at least one tooling apparatus comprises a detection unit for detecting a process parameter.

7. The transport apparatus according claim 3, wherein the at least one tooling unit comprises a tool or a tool holding unit for holding at least one tool, wherein the at least one tool can favourably be selected from the group of manufacturing tools comprising a forming tool, a separating tool, a joining tool, a coating tool, a generative manufacturing method tool and a transport tool and a marking tool.

8. The transport apparatus according to claim 1, wherein at least two transport devices are moveably arranged on a common transport device level and wherein the common transport device level is arranged between a transport device level and another transport device level.

9. The transport apparatus according to claim 1, wherein at least one transport device is a material storage carriage or a tool changing carriage or a material transport carriage comprising a double-fork transport carriage or aspiration apparatus transport carriage.

10. The transport apparatus according to claim 1, wherein at least two guide apparatus carriers having a longitudinal extension are arranged for guiding at least one transport device, the at least two guide apparatus carriers arranged in parallel to the at least one transport device level of the transport apparatus.

11. The transport apparatus according to claim 10, wherein at least two transport devices are provided and each guide apparatus carrier comprises at least two guide sections for guiding the transport devices, wherein, at least one of the guide sections is a guide rail section or at least one of the guide sections extends along the longitudinal extension of the guide apparatus carrier along an entire longitudinal extension of the guide apparatus carrier.

12. The transport apparatus according to claim 10, wherein at least one of the transport devices is arranged hanging on the guide apparatus carriers of the guide apparatus.

13. The transport apparatus according to claim 1, wherein a plurality of carrier supports is provided for carrying the guide apparatus carriers and wherein at least two of the carrier supports are preferably conical and arranged in a strut-free manner directly connected to at least one of the guide apparatus.

14. A transport apparatus for loading and unloading at least one material machining unit comprising a laser cutting machine or a fluid-jet cutting machine, with at least one workpiece or with at least one workpiece part detached from a workpiece comprising a guide apparatus, a plurality of transport devices arranged on the guide apparatus, wherein one of the transport devices is arranged on a first transport device level and comprises at least one moveable tooling apparatus, wherein at least one other transport device level is provided on which at least one of the other transport devices is arranged, as well as the at least one tooling apparatus being multifunctionally designed for transporting or machining the workpiece with at least one workpiece part detached from a workpiece, wherein the at least one tooling device comprises at least one tooling unit for machining or transporting a workpiece or at least one workpiece part detached from a workpiece, and wherein the at least one tooling unit is moveable relative to one of the transport device levels.

15. The transport apparatus according to claim 14, wherein at least one tooling apparatus is arranged on the at least one transport device in a pivotable or rotatable or linearly moveable manner and moveable along the at least one transport device.

16. The transport apparatus according to claim 14, wherein at least one tooling apparatus comprises at least one other tooling unit for machining or transporting a workpiece or at least one workpiece part detached from a workpiece.

17. The transport device according claim 15, wherein at least one tooling apparatus is rotatable or pivotable around an axis which is orientated in parallel to one of the transport device levels of the transport apparatus or the tooling apparatus is pivotable or rotatable around another axis which is orientated normally to one of the transport device levels of the transport apparatus or is arranged along at least one of the axes in a linearly moveable manner.

18. The transport apparatus according to claim 14 wherein at least one tooling apparatus comprises a detection unit for detecting a process parameter.

19. The transport apparatus according to claim 14, wherein at least one tooling unit comprises a tool or a tool holding unit for holding at least one tool, wherein the at least one tool can be favourably selected from the group of manufacturing tools, including a forming tool, a separating tool, a joining tool, a coating tool, a generative manufacturing method tool or a transport tool or a marking tool.

20. The transport apparatus according to claim 14, wherein at least one transport device is moveably arranged on a transport device level of the transport apparatus and at least one other transport device is moveably arranged on the same or on another transport device level of the transport apparatus relative to one another on the guide apparatus, wherein, the at least one transport device and the at least one other transport device are moveable at least in a movement direction relative to one another in an intersecting manner.

21. The transport apparatus according to claim 14, wherein at least two transport devices are moveably arranged on a common transport device level, wherein, the common transport device level is arranged between a transport device level and another transport device level.

22. The transport apparatus according to claim 14 wherein at least one transport device is a material storage carriage or a tool changing carriage or a material transport carriage comprising a double-fork transport carriage or aspiration apparatus transport carriage.

23. The transport apparatus according to claim 14, wherein at least two guide apparatus carriers, each with a longitudinal extension, are arranged for guiding at least one transport device, the at least two guide apparatus carriers arranged in parallel to the at least one transport device of the transport apparatus.

24. The transport apparatus according to claim 23, wherein at least two transport devices are provided and each guide apparatus carrier comprises at least two guide sections for guiding the transport devices, wherein, at least one of the guide sections is a guide rail section or at least one of the guide sections extends along the longitudinal extension of the guide apparatus carrier along an entire longitudinal extension of the guide apparatus carrier.

25. The transport apparatus according to claim 23, wherein the at least one of the transport devices is arranged hanging on the guide apparatus carriers of the guide apparatus.

26. The transport apparatus according to claim 14, wherein a plurality of carrier supports is provided for carrying the guide apparatus carriers, wherein at least two of the carrier supports are preferably conical and arranged in a strut-free manner directly connected to at least one of the guide apparatus.

27. (canceled)

28. (canceled)

29. (canceled)
